(19) United States
(12) Patent Application Publication
(10) Pub. No.: US 2021/0264535 A1
(43) Pub. Date: Aug. 26, 2021

(54) COMPARISON TOOL SYSTEM AND METHOD

(71) Applicants: Aaron T. Hatch, Sherrill, NY (US); Monika L. Kraus, Harwinton, CT (US)

(72) Inventors: Aaron T. Hatch, Sherrill, NY (US); Monika L. Kraus, Harwinton, CT (US)

(21) Appl. No.: 16/801,973

(22) Filed: Feb. 26, 2020

(51) Int. Cl. G06Q 40/08; G06F 16/28; G06Q 10/10

(52) U.S. Cl. CPC G06Q 40/08; G06Q 10/107; G06F 16/288

(57) ABSTRACT

An original risk relationship data store may contain records representing potential risk relationships (and each record may include an identifier and original risk attribute values). An adjusted risk relationship data store may contain records representing the plurality of potential risk relationships and at least some risk attribute values may have been adjusted from the original risk attribute value. A computer server may receive, from a remote user device, a selected potential risk relationship and retrieve the appropriate records from the original and adjusted risk relationship data stores. The server may then execute a comparison tool to automatically identify risk attribute values from the adjusted risk relationship data store that differ from the original risk attribute values and flag those values to the remote user device. After receiving information to explain each difference, a summary of the automatically identified risk attribute values, including the information to explain each difference, may be transmitted.

### BACKGROUND

An entity may enter into a risk relationship with an enterprise. For example, a small business might purchase an insurance policy (e.g., a property insurance policy, a workers' compensation insurance policy, etc.) from an insurance company. When a potential insured (e.g., a potential customer or client) initially seeks insurance from an insurance company, the insurance company generally requests various information from the potential insured to determine appropriate policy details (e.g., coverage amounts, deductibles, premiums, etc.). This original information might be supplied, for example, by having the business fill out an insurance application via an insurance agent, broker, online process, etc. The insurer may then review the information (e.g., including verifying, evaluating, and/or making adjustments to the supplied information during an underwriting process), and an appropriate insurance quote is eventually prepared that can be purchased by the potential insured.

Note that some of the original information supplied by the potential insured may be adjusted during the underwriting process. For example, an agent might have mistakenly thought that a particular business qualified for a safe practices discount, but that discount might not be included when the final insurance quote is provided. Similarly, a number of employees at a particular location might have been incorrect, an improper industry code may have been supplied, etc. Manually comparing the originally submitted information with the adjusted values to correctly identify and explain the changes to a potential insured can be a time consuming and error-prone task for an insurance agent or broker (e.g., especially when there are a substantial number of insurance attributes and/or adjustments that need to be investigated or reconciled).

It would be therefore desirable to provide systems and methods for an automated comparison tool platform that allow faster, more accurate results as compared to traditional approaches.

### SUMMARY OF THE INVENTION

According to some embodiments, systems, methods, apparatus, computer program code and means are provided for an automated comparison tool platform that permits faster, more accurate results as compared to traditional approaches and that allows for flexibility and effectiveness when acting on those results. In some embodiments, an original risk relationship data store may contain records representing potential risk relationships (and each record may include an identifier and original risk attribute values). An adjusted risk relationship data store may contain records representing the plurality of potential risk relationships and at least some risk attribute values may have been adjusted from the original risk attribute value. A computer server may receive, from a remote user device, a selected potential risk relationship and retrieve the appropriate records from the original and adjusted risk relationship data stores. The server may then execute a comparison tool to automatically identify risk attribute values from the adjusted risk relationship data store that differ from the original risk attribute values and flag those values to the remote user device. After receiving information to explain each difference, a summary of the automatically identified risk attribute values, including the information to explain each difference, may be transmitted.

Some embodiments comprise: means for receiving, from a remote user device, an indication of a selected potential risk relationship between an enterprise and an entity; means for retrieving, by the back-end application computer server from an original risk relationship data store, an electronic record associated with the selected potential risk relationship, including the original risk attribute values, wherein the original risk relationship data store contains electronic records that represent a plurality of potential risk relationships between the enterprise and at least one entity and each electronic record includes an electronic record identifier and original risk attribute values; means for retrieving, from an adjusted risk relationship data store, the electronic record associated with the selected potential risk relationship, wherein the adjusted risk relationship data store contains electronic records that represent the plurality of potential risk relationships and each electronic record includes an electronic record identifier and at least some risk attribute values have been adjusted from the original risk attribute value; means for executing a comparison tool to automatically identify risk attribute values from the adjusted risk relationship data store that differ from the original risk attribute values for the selected potential risk relationship; means for flagging the automatically identified risk attribute values to the remote user device; means for receiving, from the remote user device, information to explain each difference associated with the automatically identified risk attribute values; and means for transmitting a summary of the automatically identified risk attribute values, including the information to explain each difference.

In some embodiments, a communication device associated with a back-end application computer server exchanges information with remote devices in connection with an interactive graphical user interface. The information may be exchanged, for example, via public and/or proprietary communication networks.

A technical effect of some embodiments of the invention is an improved and computerized way to provide an automated comparison tool platform in a way that provides faster, more accurate results as compared to traditional approaches. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level block diagram of a system architecture in accordance with some embodiments.

FIG. 2 illustrates a method according to some embodiments of the present invention.

FIG. 3 is a comparison tool display in accordance with some embodiments.

FIGS. 4A and 4B are associated with a comparison tool display using a list of possible explanations according to some embodiments.

FIG. 5 is a quote selection display in accordance with some embodiments.

FIG. 6 is a comparison tool for agents display according to some embodiments.

FIG. 7 is an account display in accordance with some embodiments.

FIG. 8 is a quote comparison display using a bulk justification or explanation according to some embodiments.

FIG. 9 is a comparison tool output display in accordance with some embodiments.

FIG. 10 is a more detailed high-level block diagram of a system architecture in accordance with some embodiments.

FIGS. 11 and 12 illustrate a summary report according to some embodiments.

FIG. 13 is a block diagram of an apparatus in accordance with some embodiments of the present invention.

FIG. 14 is a portion of a tabular potential insurance policy database according to some embodiments.

FIG. 15 illustrates a tablet computer displaying an automated comparison tool platform user interface according to some embodiments.

FIG. 16 illustrates an overall process in accordance with some embodiments.

### DETAILED DESCRIPTION

The present invention provides significant technical improvements to facilitate electronic messaging and dynamic data processing. The present invention is directed to more than merely a computer implementation of a routine or conventional activity previously known in the industry as it significantly advances the technical efficiency, access, and/or accuracy of communications between devices by implementing a specific new method and system as defined herein. The present invention is a specific advancement in the area of electronic risk analysis and/or resource allocation by providing benefits in data accuracy, data availability, and data integrity and such advances are not merely a longstanding commercial practice. The present invention provides improvement beyond a mere generic computer implementation as it involves the processing and conversion of significant amounts of data in a new beneficial manner as well as the interaction of a variety of specialized client and/or third-party systems, networks, and subsystems. For example, in the present invention information may be processed, updated, and analyzed via a back-end-end application server to accurately compare risk relationship information, the allocation of resources, and/or the exchange of information, thus improving the overall efficiency of the computer system associated with message storage requirements and/or bandwidth considerations (e.g., by reducing the number of messages that need to be transmitted via a communication network). Moreover, embodiments associated with collecting accurate information might further improve risk values, predictions of risk values, allocations of resources, electronic record routing and signal generation, the automatic establishment of communication links, etc.

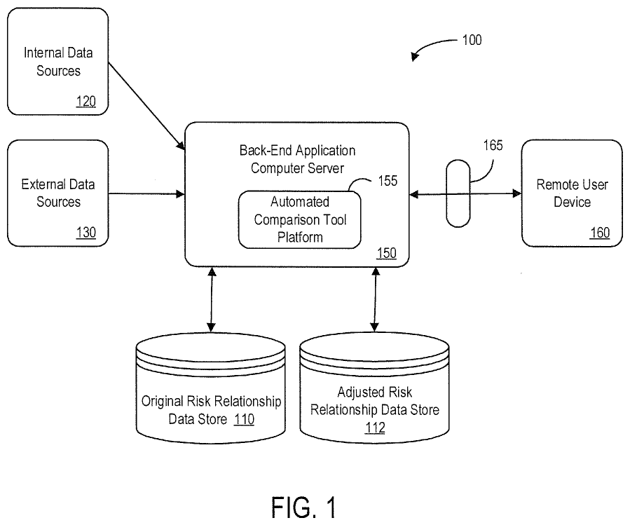

For example, FIG. 1 is a high-level block diagram of a system 100 according to some embodiments of the present invention. In particular, the system 100 includes a back-end application computer 150 server that may access information in an original risk relationship data store 110 and adjusted risk relationship data store 112 (e.g., storing a set of electronic records that represent originally submitted risk relationship data and/or adjusted risk relationship data, each record including, for example, one or more risk relationship identifiers, risk attributes, adjustment explanations, communication addresses, etc.). The back-end application computer server 150 may also retrieve information from internal data sources 120 (e.g., internal to an insurance company or an employer system) and/or external data sources 130 (e.g., third-party data) in connection with an automated comparison tool platform 155. According to some embodiments, the system 100 further applies machine learning, artificial intelligence algorithms, business logic, and/or other models to the electronic records. The back-end application computer server 150 may also exchange information with a remote user device 160 associated with a potential insured, insurance agent, broker, operator, administrator, etc. (e.g., via communication port 165 that might include a firewall). According to some embodiments, an interactive graphical user interface platform of the back-end application computer server 150 (and, in some cases, third-party data) may facilitate the display of information associated with the automated comparison tool platform 155 via one or more remote computers (e.g., to enable a manual review of automatically generated communications) and/or the remote user device 160. For example, the remote user device 160 may receive updated information (e.g., a summary report and/or insurance quote) from the back-end application computer server 150. Based on the updated information, a user may review the data from the original risk relationship data store 110 and adjusted risk relationship data store 112 and take informed actions in response to communications. Note that the back-end application computer server 150 and/or any of the other devices and methods described herein might be associated with a cloud-based environment and/or a vendor that performs a service for an enterprise.

The back-end application computer server 150 and/or the other elements of the system 100 might be, for example, associated with a Personal Computer (“PC”), laptop computer, smartphone, an enterprise server, a server farm, and/or a database or similar storage devices. According to some embodiments, an “automated” back-end application computer server 150 (and/or other elements of the system 100) may facilitate communications with remote user devices 160 and/or updates of electronic records in the original risk relationship data store 110 and adjusted risk relationship data store 112. As used herein, the term “automated” may refer to, for example, actions that can be performed with little (or no) intervention by a human.

As used herein, devices, including those associated with the back-end application computer server 150 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The back-end application computer server 150 may store information into and/or retrieve information from the original risk relationship data store 110 and adjusted risk relationship data store 112. The original risk relationship data store 110 and adjusted risk relationship data store 112 might, for example, store electronic records representing a plurality of risk relationships and/or potential risk relationships, each electronic record having a risk relationship identifier, risk attributes, communication addresses, etc. The original risk relationship data store 110 and adjusted risk relationship data store 112 may also contain information about prior and current interactions with entities, including those associated with the remote user devices 160 (e.g., user preference values associated with data formats, protocols, etc.). The original risk relationship data store 110 and adjusted risk relationship data store 112 may be locally stored or reside remote from the back-end application computer server 150. As will be described further below, the original risk relationship data store 110 and adjusted risk relationship data store 112 may be used by the back-end application computer server 150 in connection with an interactive user interface to provide information about the automated comparison tool platform 155. Although a single back-end application computer server 150 is shown in FIG. 1, any number of such devices may be included. Moreover, various devices described herein might be combined according to embodiments of the present invention. For example, in some embodiments, the back-end application computer server 150, the original risk relationship data store 110, and the adjusted risk relationship data store 112 might be co-located and/or may comprise a single apparatus.

In this way, the system 100 may provide an ability to compare a new business submission (e.g., an insurance quote) to an initial rating and point out any differences that will need to be explained to a potential insured (and thus facilitate a “what is different” talk with insurance agents and brokers).

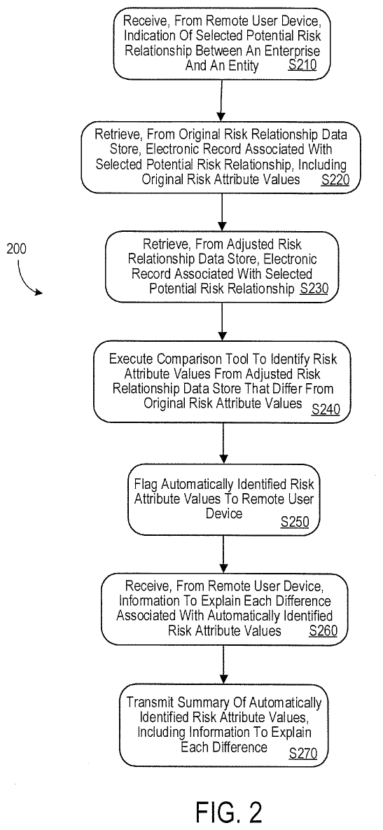

Note that the system 100 of FIG. 1 is provided only as an example, and embodiments may be associated with additional elements or components. FIG. 2 illustrates a method 200 that might be performed by some or all of the elements of the system 100 described with respect to FIG. 1, or any other system, according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S210, a back-end application computer server (e.g., associated with an enterprise) may receive, from a remote user device, an indication of a selected potential risk relationship between an enterprise and an entity (e.g., between an insurance company and a potential insured). The remote user device might be associated with, for example, an insurance agent or broker.

At S220, the back-end application computer server may retrieve, from an original risk relationship data store, an electronic record associated with the selected potential risk relationship, including original risk attribute values. The original risk relationship data store may contain, according to some embodiments, electronic records that represent a plurality of potential risk relationships between the enterprise and at least one entity and each electronic record includes an electronic record identifier and original risk attribute values.

At S230, the system may retrieve, from an adjusted risk relationship data store, an electronic record associated with the selected potential risk relationship. The adjusted risk relationship data store may contain, according to some embodiments, electronic records that represent the plurality of potential risk relationships. Note that each electronic record may include an electronic record identifier and at least some risk attribute values may have been adjusted from the original risk attribute value (e.g., during an insurance underwriting process).

At S240, a comparison tool may be executed to automatically identify risk attribute values from the adjusted risk relationship data store that differ from the original risk attribute values for the selected potential risk relationship (e.g., by more than a pre-determined threshold value or percentage). According to some embodiments, the comparison tool further executes based on internal data of the enterprise and external data.

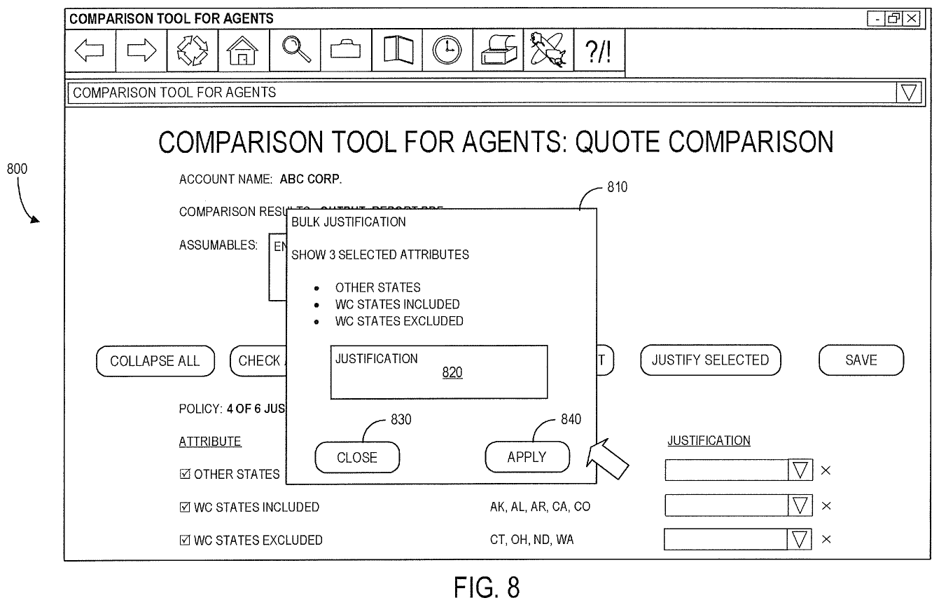

At S250, the automatically identified risk attribute values may be flagged to the remote user device. At S260, the system may receive, from the remote user device, information to explain each difference associated with the automatically identified risk attribute values. The information might include, for example, text data, documentation (e.g., spreadsheets, document images, etc.), photographs, video links, audio files, etc. According to some embodiments, the information to explain a difference associated with a plurality of automatically identified risk attribute values may be received as a bulk explanation as described with respect to FIG. 8. Note that the receipt of information to explain a difference may be received from the remote user device via selection from a list of possible explanations. The list of possible explanations may represent, for example, a list of previously received explanations.

At S270, a summary of the automatically identified risk attribute values, including the information to explain each difference, may be transmitted (e.g. to the remote user device). According to some embodiments, the selected potential risk relationship is associated with a communication address and the transmission of the summary at S270 is automatically sent to the communication address. The communication address might be associated with, for example, a postal address, an email address, a telephone number, a text message, a chat interface, a video communication link, etc. In some embodiments, the summary that is transmitted at S270 further includes assumable information received from the remote user device and/or a request for missing information (e.g., the underwriter might ask for clarification about certain details associated with a small business insurance policy).

According to some embodiments, the selected potential risk relationship is a potential insurance policy between an insurer and an insured. The potential insurance policy might be associated with, for example, a general liability insurance policy, a property insurance policy, a workers' compensation insurance policy, business insurance, etc. In this case, the remote user device may be associated with an insurance agent or broker, and the original risk relationship data store is associated with original submissions from the insurance agent or broker. Moreover, the adjusted risk relationship data store may be associated with a quote proposal from an insurance underwriter. In such situations, the summary might include an insured identifier, an insurer identifier, a report creation date, an agency or broker identifier, an insurance policy number, a Line Of Business (“LOB”), an insurance policy period, etc. The summary may further include a policy element, an original policy value, a quoted policy value, a justification rational, assumed values, etc.

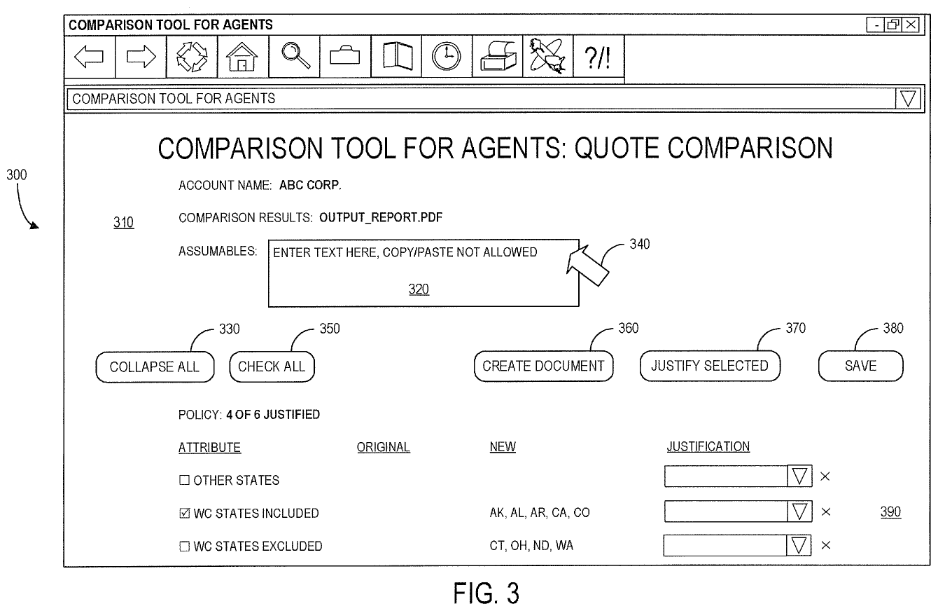

FIG. 3 is a comparison tool Graphical User Interface (“GUI”) display 300 in accordance with some embodiments. The display 300 might provide an overall interface 310 of a comparison tool for insurance agents system. The interface 310 might include, for example, an account name, manually entered assumables 320, and a “Collapse All” icon 330 that might collapse (or expand) information about multiple policies. According to some embodiments, selection of an element (e.g., via touch screen or a computer mouse pointer 340) might result in a pop-up window providing additional information about that element (e.g., linking to data sources, algorithm parameters, etc.). Moreover, selection of an “Check All” icon 350 may select multiple insurance policies. Similarly, a user might have the ability to “Create Document” 360, “Justify Selected” 370 (as explained in connection with FIG. 8), and/or to “Save” 380 the currently entered information. The display 300 also includes details 390 about insurance policies, such as an attribute description, an original value, a new or adjusted value, an explanation or justification for the change, etc. Note that if the “original” value is identical to the “new” value, the attribute would not be included on the display 300 (because there was no adjustment to that value). According to some embodiments, the display 300, along with other displays described herein, may give an operator, administrator, insurance agent, or broker a high-level, holistic view that aggregates data from various disparate sources in connection with insurance quotes. Such a view may help an enterprise configure and execute the computer system in a more efficient and accurate manner. Some embodiments might utilize ANGULAR® User Interface (“UI”) framework to help generate HTML and JavaScript data for common UI components and support overall look-and-feel guidelines with relatively little extra effort.

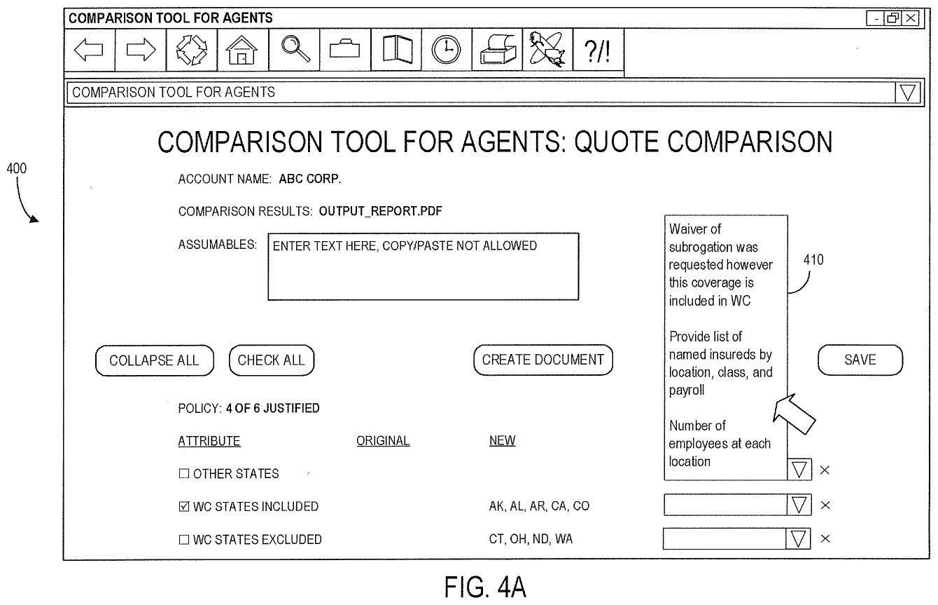

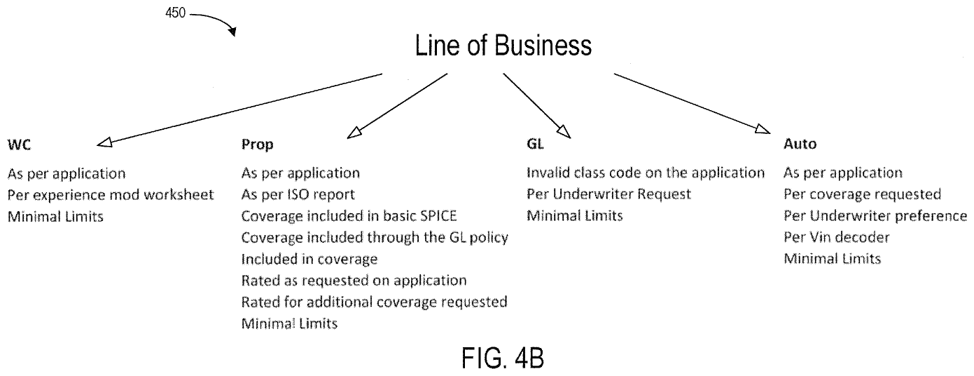

The display 300 may let a user provide an explanation or justification for any adjustments that have been automatically detected. For example, FIG. 4A is a comparison tool display 400 using a list of possible explanations 410 according to some embodiments. According to some embodiments, the list 410 includes explanations that have been supplied by the user (or by other users) in the last for similar types of attributes. According to some embodiments, the list of explanations or “justifications” may depend on a type of risk relationship between an enterprise and an entity. For example, FIG. 4B illustrates different sets of justifications 450 that are available depending on a particular line of business that is associated with an insurance policy. In this example, different sets of justifications 450 are available for workers' compensation (“WC”), property (“Prop”), general liability (“GL”), and automotive (“Auto”) insurance policies.

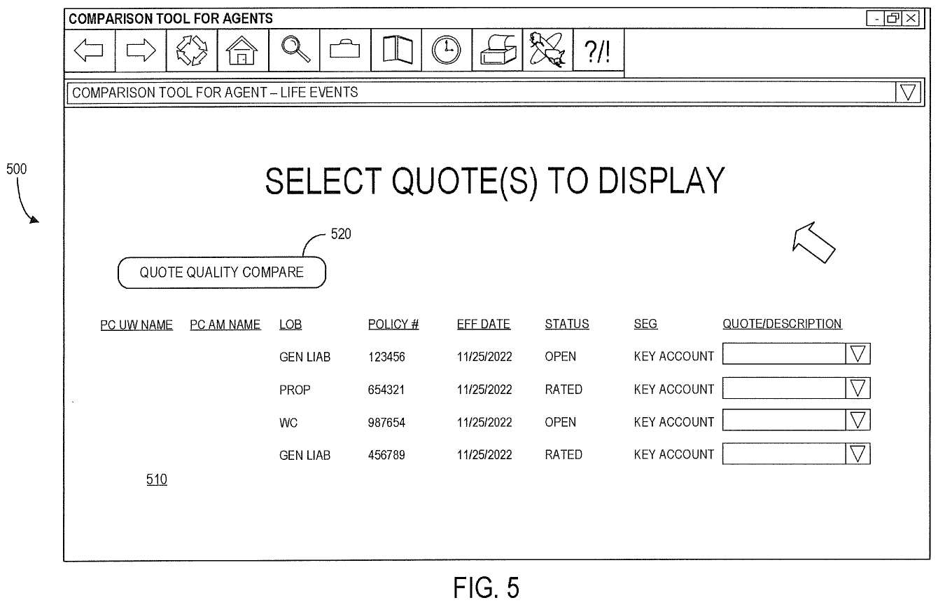

FIG. 5 is a quote selection display 500 in accordance with some embodiments. The display 500 includes information about multiple insurance policy quotes 510, such an underwriter name, account manager name, LOB, effective date, status (e.g., open or rated), segment, and/or a description of a particular quote. Selection of a “Quote Quality Compare” icon 520 may launch a stand-alone internal application that will automatically compare a new business submission with an initial rating.

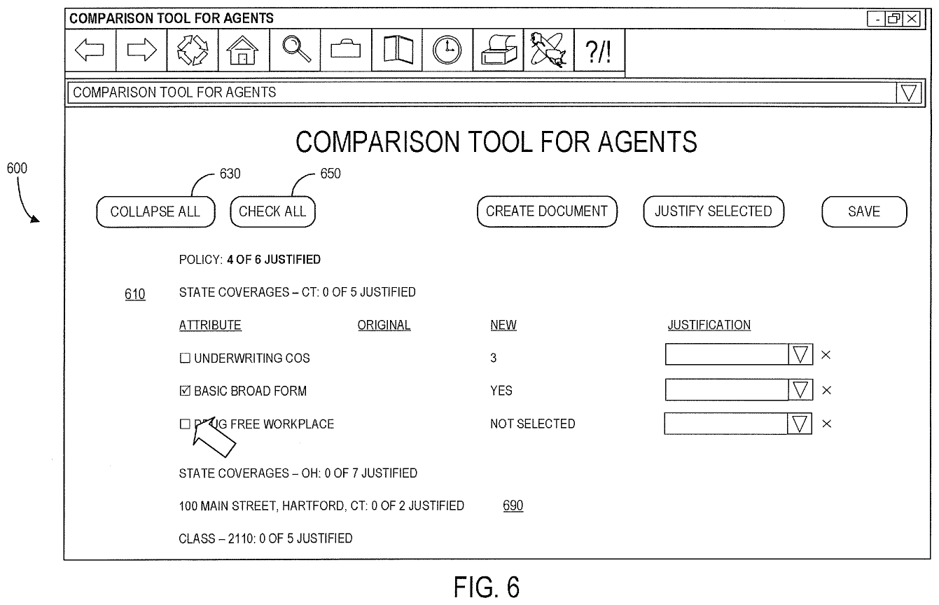

FIG. 6 is a comparison tool for agents display 600 according to some embodiments. The display 600 includes details 610 for various insurance policies being compared, including attributes (e.g., underwriting companies, basic broad form, drug free workplace, etc.), original values, new or adjusted values, and justifications. A “Collapse All” icon 630 may be used to expand (or collapse) those policies. Note that each attribute includes a user-selectable check box that can be used to designate that attribute (e.g., the “basic broad form” has been selected by the user in the example of FIG. 6), and a “Check All” icon 650 may be used to selected multiple attributes (e.g., to create a bulk explanation or justification as described with respect to FIG. 8). The display 600 further includes information 690 about other selections that might be expanded or collapsed (e.g., based on address, classification, etc.).

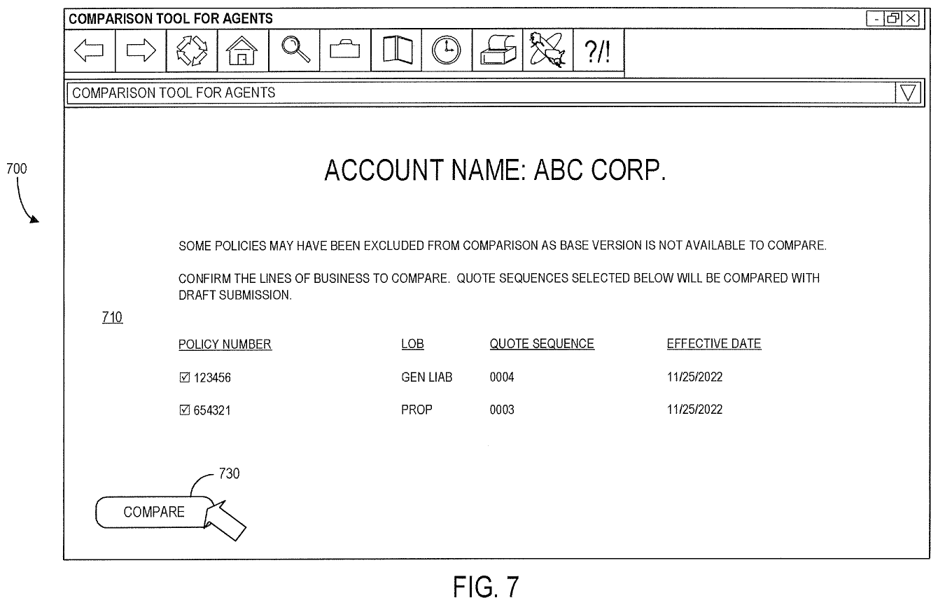

FIG. 7 is an account display 700 in accordance with some embodiments. As illustrated in FIG. 7, the account display 700 may include an account name and a list of potential insurance policies 710 that may be compared (including, for each potential insurance policy, a policy number, LOB, quote sequence, and effective date). Note that some policies might be excluded from comparison when a base version is not available for comparison. The user may “check off” some or all of the policies and then select a “Compare” icon to initiate the automatic process.

FIG. 8 is a quote comparison display 800 using a bulk justification or explanation according to some embodiments. Here, the user has “checked off” three attributes: other states, Workers' Compensation (“WC”) states included, and WC states excluded. A bulk justification pop-up window 810 appears and the user can enter a single justification 820 (e.g., by entering text) that will be applied to all three attributes. Such an approach may save the user time (because he or she does not need to select the same explanation or justification separately for each of the three attributes). Selection of a “Close” icon 830 may remove the pop-up window 810, and selection of an “Apply” icon 840 may result in the justification 820 being applied to the selected attributes.

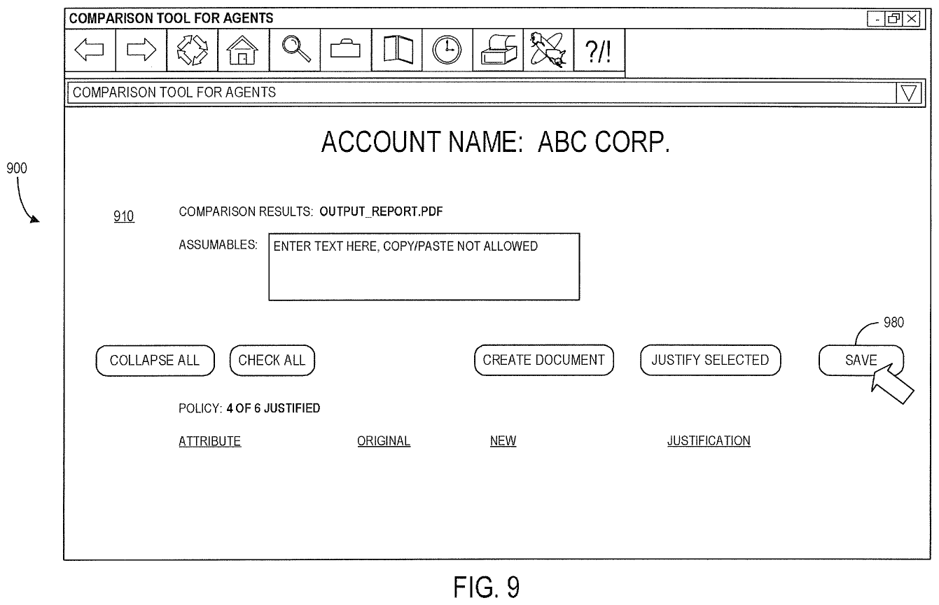

FIG. 9 is an output display 900 in accordance with some embodiments. In particular, the display 900 lets a user define where the comparison result 910 documentation will be stored (e.g., in “OUTPUT_REPORT.PDF” in the example of FIG. 9). Selection of a “Save” icon 980 may result in the information from the display being saved 980 for later access.

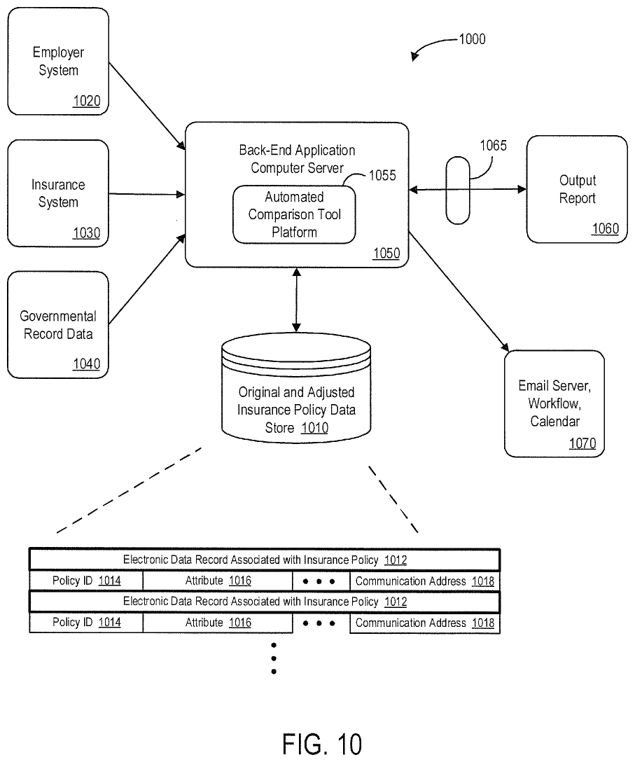

FIG. 10 is a more detailed high-level block diagram of a system 1000 in accordance with some embodiments. As before, the system 1000 includes a back-end application computer server 1050 that may access information in an insurance policy data store 1010. The back-end application computer server 1050 may also retrieve information from an employer system 1020 (e.g., a human resources spreadsheet listing employees and office addresses), an insurance system 1030, and/or government record data 1040 in connection with an automated comparison tool platform 1055. According to some embodiments, the government record data 1040 might be associated with a governmental insurance program (e.g., a list of “healthcare for all” enrollees). Note that various data elements from the insurance policy data store 1010, employer system 1020, insurance system 1030, and/or government record data 1040 might be combined, merged, verified, etc. The back-end application computer server 1050 may also exchange information via communication links to transmit output reports 1060 (e.g., via a communication port 1065 that might include a firewall) to communicate with agents and brokers. The back-end application computer server 1050 might also transmit information directly to an email server (e.g., to send insurance quote materials), a workflow application, and/or a calendar application 1070 (e.g., to schedule a telephone call to discuss changes made to an initial set of values) to facilitate automated communications and/or other system actions.

The back-end application computer server 1050 may store information into and/or retrieve information from the insurance policy data store 1010. The insurance policy data store 1010 might, for example, store electronic records 1012 representing a plurality of insurance policies, each electronic record including an insurance policy identifier 1014, a set of attributes 1016, a communication address 1018, etc. According to some embodiments, the system 1000 may also provide a dashboard view of insurance quotes and/or supporting material (e.g., including acceptance rates, financial results, etc.).

According to some embodiments, the system may use a Representational State Transfer (“REST”) web service, such as a Spring Boot framework, to spin up a basic structure of the back-end application computer server 1055. This may simplify the amount of detailed configuration that is required by leveraging the substantial set of Java annotations that Spring provides. The simplified configuration steps may also reduce the complexity of resulting code for maintenance (as well as extension). A Spring framework may shorten the time it takes to configure a new service from hours/days to minutes (fostering incremental evolutions of a new system).

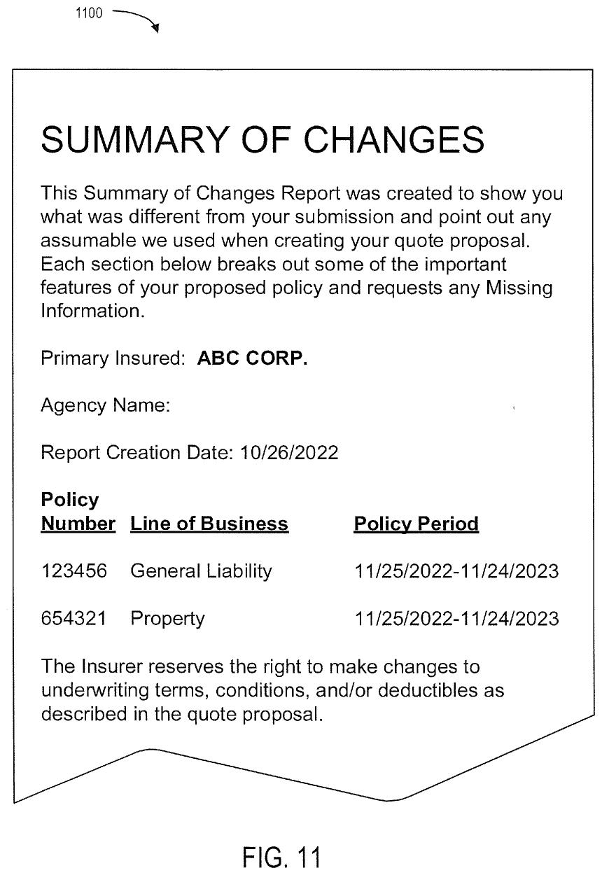

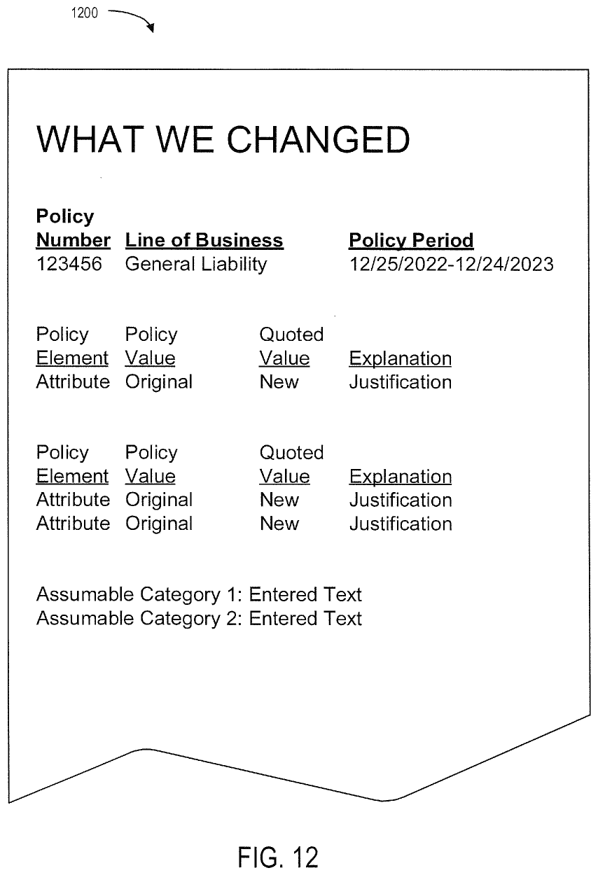

FIGS. 11 and 12 illustrate a summary report according to some embodiments (e.g., a report that summarizes the changes, differences, and/or adjustments that have been made). In particular, FIG. 11 shows page one 1100 of a summary of changes report that includes the primary insured, agency name, policy number(s), LOB, and policy period(s) of the policies that were compared by the tool. FIG. 12 shows page two 1200 of the summary of changes report that includes the policy number, LOB, policy period, particular policy elements, policy values, quoted values, explanations or justifications for those changes, assumable information, etc. Note that additional pages might be included in the summary report if additional insurance polices had been compared by the tool. Moreover, the summary of changes might be grouped in accordance with an insurance policy type or line of business. For example, a general liability policy might include general elements, elements grouped by various buildings, and, for each building, elements grouped by classification. Similarly, an automotive policy might be grouped by vehicles, ZIP code, etc. while a property policy might be grouped by location.

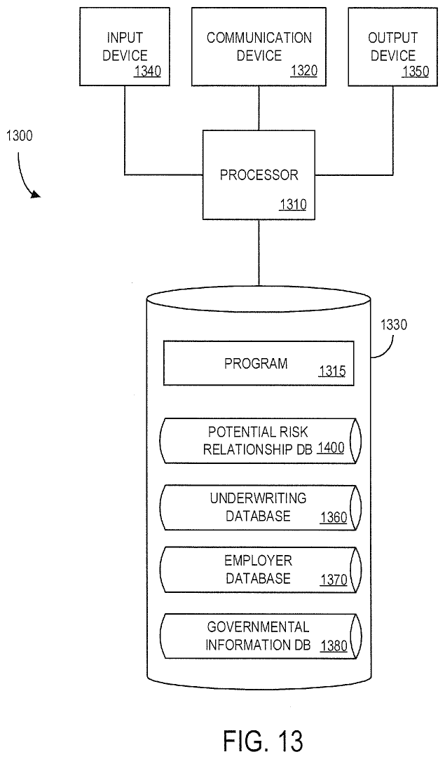

The embodiments described herein may be implemented using any number of different hardware configurations. For example, FIG. 13 illustrates an apparatus 1300 that may be, for example, associated with the systems 100, 1000 described with respect to FIGS. 1 and 10, respectively. The apparatus 1300 comprises a processor 1310, such as one or more commercially available Central Processing Units (“CPUs”) in the form of one-chip microprocessors, coupled to a communication device 1320 configured to communicate via communication network (not shown in FIG. 13). The communication device 1320 may be used to communicate, for example, with one or more remote administrator computers and or communication devices (e.g., PCs and smartphones). Note that communications exchanged via the communication device 1320 may utilize security features, such as those between a public internet user and an internal network of the insurance enterprise. The security features might be associated with, for example, web servers, firewalls, and/or PCI infrastructure. The apparatus 1300 further includes an input device 1340 (e.g., a mouse and/or keyboard to enter information about comparison thresholds, rules and logic, etc.) and an output device 1350 (e.g., to output reports regarding insurance quotes and comparison summaries).

The processor 1310 also communicates with a storage device 1330. The storage device 1330 may comprise any appropriate information storage device, including combinations of magnetic storage devices (e.g., a hard disk drive), optical storage devices, mobile telephones, and/or semiconductor memory devices. The storage device 1330 stores a program 1315 and/or a resource allocation tool or application for controlling the processor 1310. The processor 1310 performs instructions of the program 1315, and thereby operates in accordance with any of the embodiments described herein. For example, the processor 1310 might access an original risk relationship data store that contains records representing potential risk relationships (and each record may include an identifier and original risk attribute values). An adjusted risk relationship data store may contain records representing the plurality of potential risk relationships and at least some risk attribute values may have been adjusted from the original risk attribute value. The processor 1310 may receive, from a remote user device, a selected potential risk relationship and retrieve the appropriate records from the original and adjusted risk relationship data stores. The processor 1310 may then execute a comparison tool to automatically identify risk attribute values from the adjusted risk relationship data store that differ from the original risk attribute values and flag those values to the remote user device. After receiving information to explain each difference, a summary of the automatically identified risk attribute values, including the information to explain each difference, may be transmitted by the processor 1310.

The program 1315 may be stored in a compressed, uncompiled and/or encrypted format. The program 1315 may furthermore include other program elements, such as an operating system, a database management system, and/or device drivers used by the processor 1310 to interface with peripheral devices.

As used herein, information may be “received” by or “transmitted” to, for example: (i) the back-end application computer server 1300 from another device; or (ii) a software application or module within the back-end application computer server 1300 from another software application, module, or any other source.

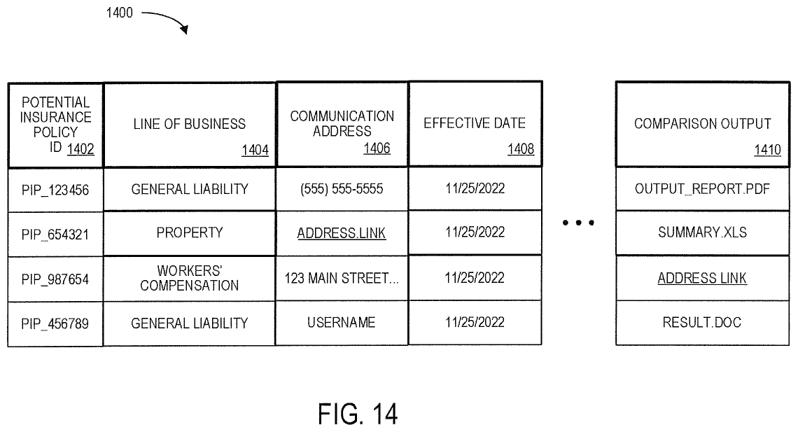

In some embodiments (such as shown in FIG. 13), the storage device 1330 further stores a potential risk relationship database 1400 (e.g., containing insurance policy information), an underwriting database 1360, an employer database 1370, and a governmental information database 1380. An example of a database that might be used in connection with the apparatus 1300 will now be described in detail with respect to FIG. 14. Note that the database described herein is only an example, and additional and/or different information may be stored therein. Moreover, various databases might be split or combined in accordance with any of the embodiments described herein. For example, the potential risk relationship database 1400 and the underwriting database 1360 might be combined and/or linked to each other within the program 1315.

Referring to FIG. 14, a table is shown that represents the potential risk relationship database 1400 that may be stored at the apparatus 1300 according to some embodiments. The table may include, for example, entries associated with potential insurance sales opportunities. The table may also define fields 1402, 1404, 1406, 1408, 1410 for each of the entries. The fields 1402, 1404, 1406, 1408, 1410 may, according to some embodiments, specify: a potential insurance policy identifier 1402, a LOB 1404, a communication address 1406, an effective date 1408, and a comparison output 1410. The potential risk relationship database 1400 may be created and updated, for example, based on information electrically received from various operators, administrators, and computer systems (e.g., including those of an insurance underwriter, agent, or broker) that may be associated with an insurer.

The potential insurance policy identifier 1402 may be, for example, a unique alphanumeric code identifying an insurance policy sales opportunity. The LOB 1404 might describe the type of insurance (e.g., general liability, property, workers' compensation, etc.). The communication address 1406 might be postal address, telephone number, communication link, etc. that can be used to transmit information about the results of an automated comparison process. The effective date 1408 might describe when the insurance policy would begin. The comparison output 1410 might indicate a file, link, document, etc. that contains the result of the automated comparison process.

Thus, embodiments may provide an automated and efficient way for a comparison tool platform to allow for faster, more accurate results as compared to traditional approaches. Embodiments may improve the experience of an insurance agent or broker (who can avoid wasting time and the need to come back with questions). Similarly, embodiments may save time for account managers (who do not need to revisit reconciliation issues).

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the displays described herein might be implemented as a virtual or augmented reality display and/or the databases described herein may be combined or stored in external systems). Moreover, although embodiments have been described with respect to particular types of insurance policies, any of the embodiments may instead be associated with other types of insurance policies in addition to and/or instead of the policies described herein (e.g., professional liability insurance policies, extreme weather insurance policies, new business, policy renewals, issued policies, etc.). Similarly, although certain attributes (e.g., insurance policy values) were described in connection some embodiments herein, other types of attributes might be used instead.

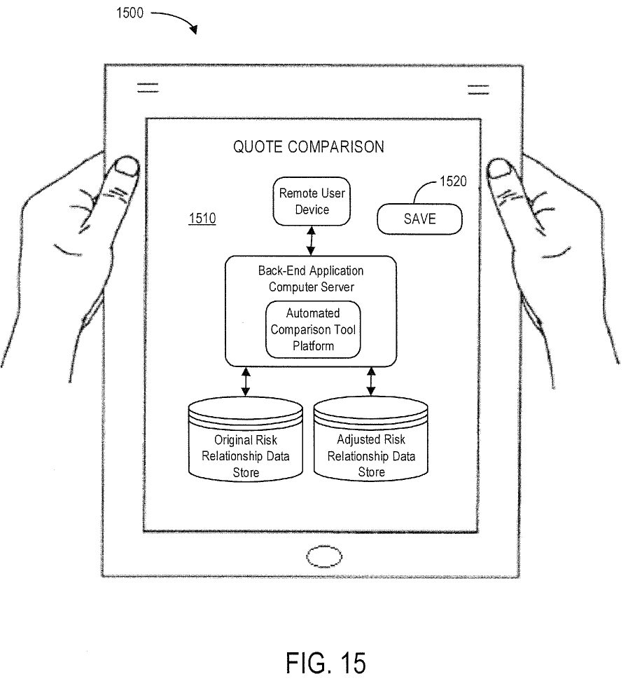

Further, the displays and devices illustrated herein are only provided as examples, and embodiments may be associated with any other types of user interfaces. For example, FIG. 15 illustrates a handheld tablet computer 1500 showing an automated comparison tool platform display 1510 according to some embodiments. The comparison tool platform display 1510 might include user-selectable data that can be highlighted and/or modified by a user of the handheld computer 1510 to provide information about potential risk relationship comparisons. Moreover, selection of a “Save” icon 1520 may store the values to be used by any of the embodiments described herein.

Note that the displays described herein might be constantly updated based on new information (e.g., as data is received by the insurer). For example, the displays might be updated in substantially real time or on a periodic basis (e.g., once each night). According to some embodiments, an underwriter, agent, or broker might be able to select a particular time in the past and the displays may be updated to reflect the information as it previously existed at that particular time (e.g., what would a user have seen one year ago?).

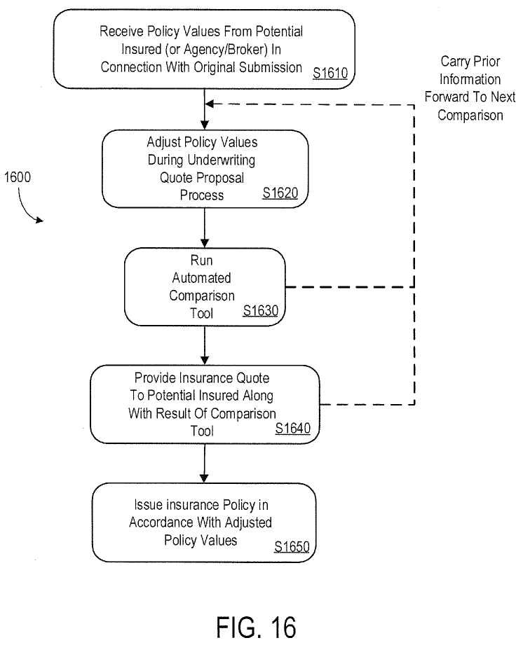

FIG. 16 illustrates an overall business process 1600 in accordance with some embodiments. At S1610, an insurer may receive information about a potential insurance policy, including original policy values. At S1620, an underwriter might adjust some of those values. At S1630, an automated comparison tool may be run (and appropriate explanations may be collected). At S1640, an insurance quote may then be provided along with the result of the comparison tool to explain any differences. The insurer may then issue the insurance policy in accordance with the adjusted insurance policy values at S1650. Note that at any point in the process 1600, the automated comparison tool might be executed multiple times (as illustrated by the dashed arrow in FIG. 16). For example, an underwriter might run the tool, decide to make some additional updates, and then run the tool again. Similarly, an insurance agent or broker might view the results of a comparison, suggest some changes, and then request that a new comparison be performed. In any of these cases, information associated with a prior comparison may be “carried forward” in the tool for a subsequent comparison. For example, adjusted attribute values and/or associated justifications might be automatically carried forward and used in a new comparison (so that this information does not need to be repeatedly entered into the system). Similarly, information entered about one policy might be carried over to another policy (e.g., a business name, address, etc. entered for a workers' compensation comparison might be automatically carried over to a general liability comparison).

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A system to provide an automated comparison tool platform via a back-end application computer server of an enterprise, comprising:
(a) an original risk relationship data store containing electronic records that represent a plurality of potential risk relationships between the enterprise and at least one entity, wherein each electronic record includes an electronic record identifier and original risk attribute values;
(b) an adjusted risk relationship data store containing electronic records that represent the plurality of potential risk relationships, wherein each electronic record includes an electronic record identifier and at least some risk attribute values have been adjusted from the original risk attribute value;
(c) the back-end application computer server, coupled to the risk relationship data store, programmed to:
(i) receive, from a remote user device, an indication of a selected potential risk relationship between the enterprise and the entity,
(ii) retrieve, from the original risk relationship data store, the electronic record associated with the selected potential risk relationship, including the original risk attribute values,
(iii) retrieve, from the adjusted risk relationship data store, the electronic record associated with the selected potential risk relationship,
(iv) execute a comparison tool to automatically identify risk attribute values from the adjusted risk relationship data store that differ from the original risk attribute values for the selected potential risk relationship,
(v) flag the automatically identified risk attribute values to the remote user device,
(vi) receive, from the remote user device, information to explain each difference associated with the automatically identified risk attribute values, and
(vii) transmit a summary of the automatically identified risk attribute values, including the information to explain each difference; and
(d) a communication port coupled to the back-end application computer server to facilitate an exchange of data with the remote user device in support of a graphical interactive user interface display via a distributed communication network, the interactive user interface display including the summary of the automatically identified risk attribute values and the information to explain each difference.

2. The system of claim 1, wherein the selected potential risk relationship is associated with a communication address and said transmission of the summary is automatically sent to the communication address.

3. The system of claim 2, wherein the communication address is associated with at least one of: (i) a postal address, (ii) an email address, (iii) a telephone number, (iv) a text message, (v) a chat interface, and (vi) a video communication link.

4. The system of claim 1, wherein the comparison tool further executes based on internal data of the enterprise and external data.

5. The system of claim 1, wherein information to explain a difference associated with a plurality of automatically identified risk attribute values is received as a bulk explanation.

6. The system of claim 1, wherein the summary further includes at least one of: (i) assumable information received from the remote user device, and (ii) a request for missing information.

7. The system of claim 1, wherein the receipt of information to explain a difference is received from the remote user device via selection from a list of possible explanations.

8. The system of claim 7, wherein the list of possible explanations represents a list of previously received explanations.

9. The system of claim 1, wherein the selected potential risk relationship is a potential insurance policy between an insurer and an insured.

10. The system of claim 9, wherein the potential insurance policy is associated with at least one of: (i) a general liability insurance policy, (ii) a property insurance policy, (iii) a workers' compensation insurance policy, and (iv) business insurance.

11. The system of claim 9, wherein the remote user device is associated with an insurance agent or broker.

12. The system of claim 11, wherein the original risk relationship data store is associated with original submissions from the insurance agent or broker.

13. The system of claim 12, wherein the adjusted risk relationship data store is associated with a quote proposal from an insurance underwriter.

14. The system of claim 13, wherein the summary includes at least one of: (i) an insured identifier, (ii) an insurer identifier, (iii) a report creation date, (iv) an agency or broker identifier, (v) an insurance policy number, (vi) a line of business, and (vii) a policy period.

15. The system of claim 14, wherein the summary further includes at least one of: (i) a policy element, (ii) an original policy value, (iii) a quoted policy value, (iv) a justification rational, and (v) assumed values.

16. A computerized method to provide an automated comparison tool platform via a back-end application computer server of an enterprise, comprising:
receiving, from a remote user device, an indication of a selected potential risk relationship between the enterprise and an entity;
retrieving, by the back-end application computer server from an original risk relationship data store, an electronic record associated with the selected potential risk relationship, including the original risk attribute values, wherein the original risk relationship data store contains electronic records that represent a plurality of potential risk relationships between the enterprise and at least one entity and each electronic record includes an electronic record identifier and original risk attribute values;
retrieving, from an adjusted risk relationship data store, the electronic record associated with the selected potential risk relationship, wherein the adjusted risk relationship data store contains electronic records that represent the plurality of potential risk relationships and each electronic record includes an electronic record identifier and at least some risk attribute values have been adjusted from the original risk attribute value;
executing a comparison tool to automatically identify risk attribute values from the adjusted risk relationship data store that differ from the original risk attribute values for the selected potential risk relationship;
flagging the automatically identified risk attribute values to the remote user device;
receiving, from the remote user device, information to explain each difference associated with the automatically identified risk attribute values; and
transmitting a summary of the automatically identified risk attribute values, including the information to explain each difference.

17. The method of claim 16, wherein the selected potential risk relationship is associated with a communication address, said transmission of the summary is automatically sent to the communication address, and the communication address is associated with at least one of: (i) a postal address, (ii) an email address, (iii) a telephone number, (iv) a text message, (v) a chat interface, and (vi) a video communication link.

18. The method of claim 16, wherein information to explain a difference associated with a plurality of automatically identified risk attribute values is received as a bulk explanation.

19. A non-transitory, computer-readable medium storing instructions, that, when executed by a processor, cause the processor to perform a method to provide an automated comparison tool platform via a back-end application computer server of an enterprise, the method comprising:
receiving, from a remote user device, an indication of a selected potential risk relationship between the enterprise and an entity;
retrieving, by the back-end application computer server from an original risk relationship data store, an electronic record associated with the selected potential risk relationship, including the original risk attribute values, wherein the original risk relationship data store contains electronic records that represent a plurality of potential risk relationships between the enterprise and at least one entity and each electronic record includes an electronic record identifier and original risk attribute values;
retrieving, from an adjusted risk relationship data store, the electronic record associated with the selected potential risk relationship, wherein the adjusted risk relationship data store contains electronic records that represent the plurality of potential risk relationships and each electronic record includes an electronic record identifier and at least some risk attribute values have been adjusted from the original risk attribute value;
executing a comparison tool to automatically identify risk attribute values from the adjusted risk relationship data store that differ from the original risk attribute values for the selected potential risk relationship;
flagging the automatically identified risk attribute values to the remote user device;
receiving, from the remote user device, information to explain each difference associated with the automatically identified risk attribute values; and
transmitting a summary of the automatically identified risk attribute values, including the information to explain each difference.

20. The medium of claim 19, wherein the selected potential risk relationship is a potential insurance policy between an insurer and an insured, the remote user device is associated with an insurance agent or broker, the original risk relationship data store is associated with original submissions from the insurance agent or broker, and the adjusted risk relationship data store is associated with a quote proposal from an insurance underwriter.

21. The medium of claim 20, wherein the summary includes at least four of: (i) an insured identifier, (ii) an insurer identifier, (iii) a report creation date, (iv) an agency or broker identifier, (v) an insurance policy number, (vi) a line of business, (vii) a policy period, (viii) a policy element, (ix) an original policy value, (x) a quoted policy value, (xi) a justification rational, and (xii) assumed values.
